(19) United States
(12) Patent Application Publication
(10) Pub. No.: US 2015/0217189 A1
(43) Pub. Date: Aug. 6, 2015

(54) IN-GAME GRAPHIC RECOGNITION SYSTEM AND IN-GAME GRAPHIC RECOGNITION PROGRAM

(71) Applicant: DeNa Co., Ltd., Tokyo (JP)

(72) Inventors: Takashi NINJOUJI, Tokyo (JP); Tsuyoshi KAGEYAMA, Tokyo (JP); Takahiro OTOMO, Tokyo (JP)

(21) Appl. No.: 14/612,805

(22) Filed: Feb. 3, 2015

(30) Foreign Application Priority Data
Feb. 3, 2014 (JP) 2014-018554

(51) Int. Cl. A63F 13/213

(52) U.S. Cl. CPC A63F 13/213

(57) ABSTRACT

Game images displayed in an electronic game are analyzed and graphically recognized, a determination is made as to whether graphics recognized by the graphic recognition means are appropriate or inappropriate by checking against an inappropriate expression database where inappropriate expressions are recorded, and access to the game images is controlled in accordance with the determination result.

This application claims the benefit of foreign priority under 35 USC 119(a) based on Japanese Patent Application No. 2014-18554, filed Feb. 3, 2014, the contents of which is incorporated herein by reference in its entirety.

### BACKGROUND

1. Technical Field

The present invention relates to an in-game graphic recognition system and an in-game graphic recognition program.

2. Related Art

Technologies for detecting inappropriate character expressions using submission filters are known to be employed in network-based chat and messaging systems. In addition, technologies are known for reading documents and images using optical character recognition systems (OCR) and recognizing characters contained therein.

On the other hand, electronic gaming systems are known that make it possible to freely edit game images and enable sharing of these images with others via public telecommunication networks such as the Internet (Non-Patent Citation 1, etc.).

### PRIOR ART LITERATURE

### Non-Patent Literature

[Non-Patent Citation 1]
“Minecraft”, https://minecraft.net/

### SUMMARY OF THE INVENTION

### Problems to be Solved by the Invention

Incidentally, when a game image is shared during an electronic game, a message can be shared with third parties by representing a character string using a combination of arrangements of objects present in a game image. In such cases, it has been difficult to recognize character strings contained in game images using current OCR technology and, for this reason, it has been impossible to properly prevent sharing even when hostile and inappropriate expressions and the like appeared on a game screen.

It is an object of the present invention to provide an in-game graphic recognition system and an in-game graphic recognition program that make it possible to provide an electronic game service that enables prevention of sharing of such inappropriate information in advance and lets users play with peace of mind.

### SUMMARY

One aspect of the invention is an in-game graphic recognition system provided with: a graphic recognition means for analyzing and graphically recognizing game images displayed in an electronic game; a determination means for determining whether graphics recognized by the graphic recognition means are appropriate or inappropriate by checking against an inappropriate expression database in which inappropriate expressions are registered; and an access control means for controlling access to the game images in accordance with the determination result of the determination means.

Another aspect of the invention is an in-game graphic recognition program, which directs a computer to operate as: a graphic recognition means for analyzing and graphically recognizing game images displayed in an electronic game; a determination means for determining whether graphics recognized by the graphic recognition means are appropriate or inappropriate by checking it against an inappropriate expression database in which inappropriate expressions are registered; and a control means for controlling access to the game images in accordance with the determination result of the determination means (e.g., a non-transitory computer readable medium having machine-executable instructions for in-game graphic recognition, the machine-executable instructions directing a computer to perform analyzing and graphically recognizing game images displayed in an electronic game; determining whether graphics recognized by the analyzing and graphically recognizing are appropriate or inappropriate by checking against an inappropriate expression database where inappropriate expressions are registered; and controlling access to the game images in accordance with the determination result of the determining).

Here, the graphic recognition means preferably extracts segments that constitute graphics from information on the arrangements of the objects forming part of the game image (e.g., the analyzing and graphically recognizing comprises extracting segments that constitute graphics from information on the arrangement of the objects forming part of the game images).

In addition, the determination means preferably calculates an accumulated value produced by accumulating the number of times a determination of inappropriateness has been made, and disallows the sharing of the game images when the accumulated value exceeds a reference value.

In addition, the determination means preferably determines that a graphic recognized by the graphic recognition means is inappropriate when said graphic represents a combination of a date and a place name.

### Effects of the Invention

The present invention can provide an electronic game service that enables prevention of sharing of inappropriate information in advance and ensures peace of mind during game play.

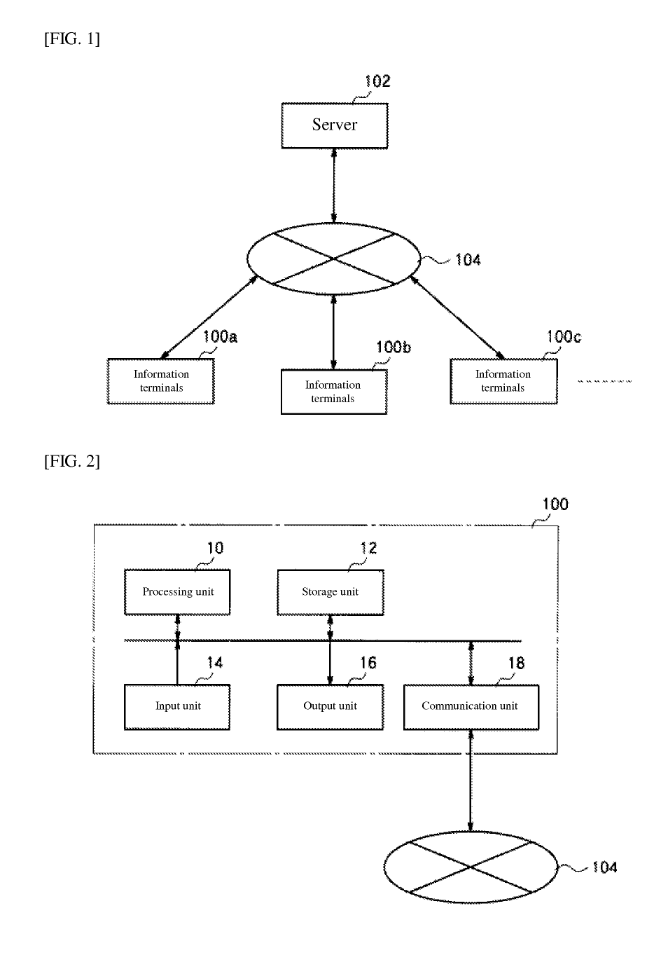

### BRIEF DESCRIPTION OF THE DRAWINGS

[FIG. 1]

A diagram illustrating the configuration of an electronic gaming system in an embodiment of the present invention.

[FIG. 2]

A diagram illustrating the configuration of an information terminal in an embodiment of the present invention.

[FIG. 3]

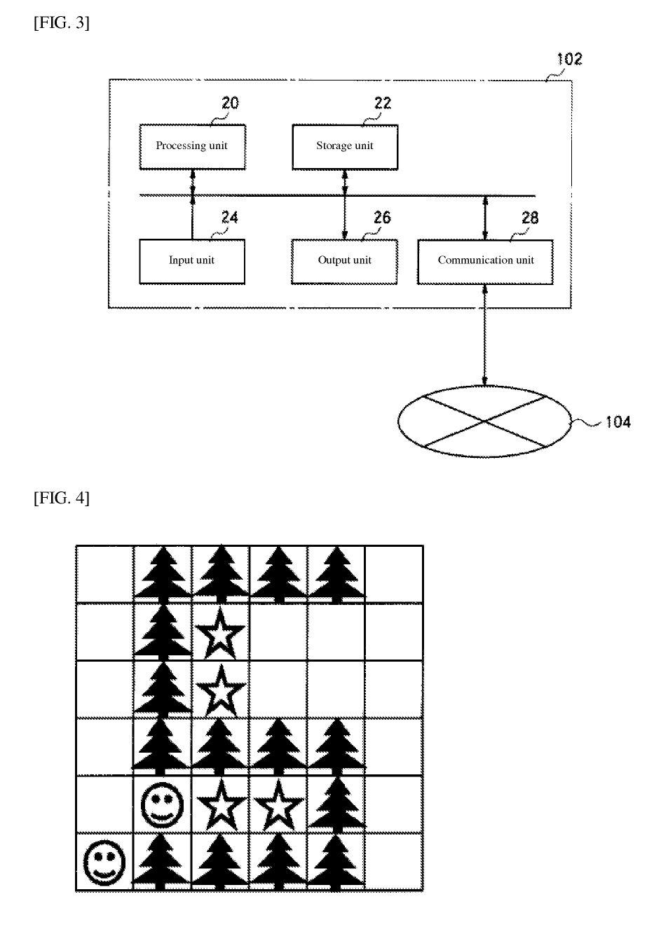

A diagram illustrating the configuration of a server in an embodiment of the present invention.

[FIG. 4]

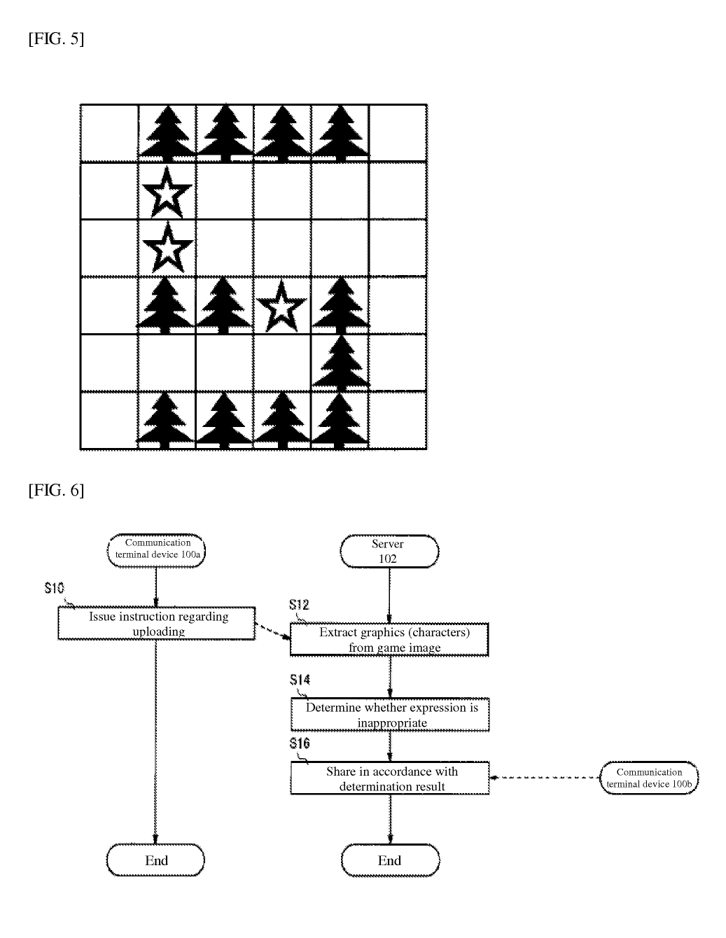

A diagram illustrating an example in which graphics (character string) are represented using object arrangements and combinations thereof in a game image.

[FIG. 5]

A diagram illustrating an example in which graphics (character string) are represented using object arrangements and combinations thereof in a game image.

[FIG. 6]

A flow chart of an invitation process in an embodiment of the present invention.

### DETAILED DESCRIPTION

As shown in FIG. 1, an electronic gaming system used in an embodiment of the present invention includes information terminals 100 and a server 102. The server 102 is communicatively connected to multiple information terminals 100 (100a, 100b . . . ) via an information communication network 104. The server 102 provides information allowing for electronic games to be played on the information terminals 100.

As shown in FIG. 2, an information terminal 100 includes a processing unit 10, a storage unit 12, an input unit 14, an output unit 16, and a communication unit 18. The basic configuration of the information terminals 100 is that of a communication-enabled mobile terminal, such as a mobile phone, a smartphone, a tablet terminal, or the like. In this embodiment, the information terminals 100 operate as electronic game devices that the users use for playing electronic games.

The processing unit 10 includes means for performing arithmetic processing, such as a CPU and the like. The processing unit 10 implements electronic game-related functions on the information terminals 100 by executing a game program (e.g., computer-readable medium including machine-executable instructions configured to be executed by a processor) stored in the storage unit 12. The storage unit 12 includes storage means, such as a semiconductor memory, a memory card, or the like. The storage unit 12 is accessibly connected to the processing unit 10 and stores electronic game software, data required for electronic game processing, as well as databases and other information. The input unit 14 includes means for entering information into the information terminals 100. The input unit 14 has, for example, a touchscreen panel, buttons, or the like for receiving input from the user. The output unit 16 includes, for example, a user interface screen (UI) for accepting input information from the user and means for outputting the results of processing by the information terminal 100. The output unit 16 is provided with a display that, for example, presents images to the user. The communication unit 18 includes an interface for exchanging information with other information communication devices via the information communication network 104. The communication unit 18 may be wired or wireless.

As shown in FIG. 3, the server 102 includes a processing unit 20, a storage unit 22, an input unit 24, an output unit 26, and a communication unit 28. The basic configuration of the server 102 is that of a computer with communication capabilities. In this embodiment, the server 102 operates as a device for providing electronic games.

The processing unit 20 includes means for performing arithmetic processing, such as a CPU. The processing unit 20 controls the functionalities that can be used on the information terminals 100 by executing a program (e.g., computer-readable medium including machine-executable instructions configured to be executed by a processor) for providing electronic games stored in the storage unit 22. In addition, by executing an in-game graphic recognition program (e.g., computer-readable medium including machine-executable instructions configured to be executed by a processor) stored in the storage unit 22, the processing unit 20 determines whether game images edited during electronic games may be shared on the network. As a result, it operates as an in-game graphic recognition system. The storage unit 22 includes storage means, such as a semiconductor memory, a hard disk, or the like. The storage unit 22 is accessibly connected to the processing unit 20 and stores a program (e.g., computer-readable medium including machine-executable instructions configured to be executed by a processor) for providing electronic games, an in-game graphic recognition program (e.g., computer-readable medium including machine-executable instructions configured to be executed by a processor), data used in electronic games acquired from the information terminals 100, as well as databases and other information. The input unit 24 includes means for entering information into the server 102. The input unit 24 has, for example, a keyboard, for receiving input from the user. The output unit 26 includes, for example, a user interface screen (UI) for accepting input information from the user and means for outputting the results of processing by the server 102. The output unit 26 is provided with a display that, for example, presents images to the user. The communication unit 28 includes an interface for exchanging information with the information terminals 100 and other information communication devices via the information communication network 104. The communication unit 28 may be wired or wireless.

In this embodiment, it is assumed that the information terminal 100a belongs to User A and the information terminal 100b belongs to User B. It is assumed that User A, who uses the information terminal 100a to play an electronic game supplied by the server 102, edits a game image editable in the electronic game and shares it with third parties (User B, etc.).

Here, the expression “sharing an image”, as used in this embodiment, refers to making this image viewable to people other than those who produced (edited) the image. For example, it refers to using the arrangements of the objects present in a game image that appears in the electronic game and combinations thereof to represent characters and graphics and making this game image viewable to others by uploading it into the Internet space.

In the electronic gaming system of this embodiment, a game image can be made viewable to third parties by uploading the image to the server 102 using an electronic game software program (e.g., computer-readable medium including machine-executable instructions configured to be executed by a processor) executed on the information terminals 100. As for the method of image uploading, existing methods can be used, for example, game images can be displayed using a website that supplies the electronic gaming system or an SNS, i.e. a community of users of the electronic gaming system. It should be noted that, as far as the type of the electronic game is concerned, the invention can be suitably applied to so-called Sandbox-type games and the like, in which players can arrange objects in arbitrary positions on the field.

In addition, in this embodiment, the term “graphics” refers to graphics represented by the number and type of the objects present in the image, the placement locations of the objects, and combinations thereof. Characters are also included in the graphics. The term “objects” includes player objects, enemy objects, item objects, building objects, background objects and the like placed within a game image during an electronic game.

For example, in the example of FIG. 4, the character of the numeral “5” is represented by placing “tree” objects, i.e. background objects in the game, within a game image. In this manner, characters and graphics can be represented using a combination of arrangements of multiple objects.

In addition, while FIG. 4 shows an example in which characters and graphics are represented using a combination of arrangements of objects of a single type, as shown in FIG. 5, characters and graphics can also be represented using a combination of arrangements of objects of multiple types. In this example, the character of the numeral “5” is represented using a combination of “tree” objects and “star” objects.

It should be noted that since there are no particular limitations regarding the content of the electronic game, and it is sufficient to be able generate or edit game images used in the electronic game, specific discussion thereof is omitted for the sake of brevity.

In-game graphic recognition in preparation for uploading a game image during an electronic game is discussed below with reference to the flow chart of FIG. 6.

When User A, who plays an electronic game on the information terminal 100a, edits a game image and prepares to upload it, the server 102 carries out processing to ascertain whether the characters and graphics contained in the game image correspond to inappropriate information. This process is described below.

At Step S10, an instruction regarding a game image upload is accepted from the information terminal 100a. The process performed in this step corresponds to the image acceptance means. User A, who plays an electronic game supplied by the server 102 on the information terminal 100a, edits object arrangement and generates a game image in this game. For example, the user edits a game image by selecting an arbitrary object from predetermined objects on the user's home page in the game or in a predetermined scene in the game and placing it at an arbitrary location on the field, moving it, or deleting it, etc. In addition, the timing of object arrangement by the user may be such that they are placed as the game progresses, or placed after clearing the stage in the game. User A enters an instruction to upload the game image to the server 102 into the information terminal 100a. After receiving the instruction to upload the game image, the information terminal 100a accesses the server 102 and transmits information indicating receipt of an upload instruction and the game image.

At Step S12, graphics (characters) are extracted from the game image in the server 102. The process performed in this step corresponds to the graphic recognition means. Upon receiving the game image from the information terminal 100a, the server 102 extracts graphics (characters) from said game image.

During the extraction process, object images are cropped out from the game image and graphics formed by connecting the objects are extracted. The processing used to extract each object from the game image can be implemented using existing image processing technology. For example, the game image can be split into partial areas of various sizes, the respective partial areas can be compared, and the areas can be extracted as objects if there are similar images. In addition, if the image data of the objects used in the electronic game is held in the server 102, objects can be cropped out from the game image using the image data.

For example, “tree” objects, “star” objects, and “face” objects are cropped out in the exemplary game image illustrated in FIG. 4. Meaningful graphics and characters are then extracted from combinations of segments produced by connecting objects of a single type or multiple types. Models of the graphics and characters subject to extraction can be registered in advance as an extracted graphic database. In the example of FIG. 4, the segment produced by connecting “tree” objects is extracted as a graphic (character) similar to the numeral “5” or Latin letter “S”. In addition, in the example of FIG. 5, a graphic (character) similar to the numeral “5” or Latin letter “S” is extracted from a segment produced by connecting “tree” objects and “star” objects.

The process of extraction of characters and graphics can be carried out by registering segment data (vector data) for characters and graphics of various types in a candidate database in advance and performing extraction based on the degree of similarity of the segment data extracted from the game image and the segment data of characters and graphics registered in the candidate database. For example, characters and graphics with a degree of similarity exceeding a preset value will be extracted. It should be noted that the process of extraction of characters and graphics is not limited to this context.

It should be noted that while FIG. 4 and FIG. 5 illustrate an example in which only 1 character is extracted from the game image, a combination of graphics and character strings made up of multiple characters is often extracted.

In addition, while in this embodiment objects present on the game screen and their arrangements are extracted using image processing, the method of extraction of characters and graphics is not limited thereto. For example, since arrangement data, which indicates the locations on the game screen where each object forming part of the game image is placed, is often stored in the electronic game, the arrangement pattern of the objects may be obtained based on the object arrangement data, and characters and graphics may be extracted from the object arrangement pattern. For example, the type of the objects and the coordinates on the field on which the objects are placed, etc., are suggested as the arrangement data. Also, the process of extraction of characters and graphics can be carried out based on the degree of similarity to the arrangement pattern data of the characters and graphics registered in the candidate database. The relative positional relationship between objects with adjacent coordinates or located in the same vicinity, etc. is suggested as the arrangement pattern data. It should be noted that arrangement patterns may be obtained by extracting only objects of the same or specific type. In addition, the extraction process may be performed by considering the possibility that the graphics may be represented with additional rotation and reduction. Based on this method, the characters and graphics present on the game screen can be identified with better precision than when using image processing.

At Step S14, a determination is made as to whether the extracted graphics (characters) are inappropriate graphics (inappropriate characters). The process performed in this step corresponds to the determination means. The server 102 matches the characters (character strings) and graphics (combinations of graphics) extracted at Step S12 against the characters (character strings) and graphics (combinations of graphics) registered in the inappropriate expression database and determines that they are inappropriate if they match or if they are similar.

Here, the inappropriate expression database is a database used to register characters (character strings) and graphics (combinations of graphics) believed to be inappropriate for viewing when game images are shared. For example, violence-related expressions and sex-related expressions believed to be undesirable for viewing by minors are registered in the inappropriate expression database.

At Step S16, game image sharing is carried out in accordance with the determination result. The process performed in this step corresponds to the access control means. The server 102 does not authorize the sharing of a game image if the characters (character strings) and graphics (combinations of graphics) extracted from the game image at Step S14 are determined to be inappropriate. In such cases, for example, the game pages that originally displayed this game image are excluded from the search objects of the game; the game image is prevented from being displayed even if other users visit the specified game pages; mosaics are applied to the game image, etc. On the other hand, the sharing of the game image is authorized if it is determined to be appropriate.

For example, if the game image is determined to be appropriate, other users are allowed to view the game image edited by User A in the game. Alternatively, this game image is uploaded to a social network service (SNS) related to the game and users subscribed to the SNS are allowed to view it. It should be noted that the sharing of game images is not limited to this context, and may be carried out by sending game images to specific users by e-mail or by distributing game images within the framework of the service that provides the electronic game.

It should be noted that the method used to restrict sharing may involve processing to completely prevent sharing or providing different levels of viewing and searching depending on, for example, the age of the users who intend to view the images.

### <Variation 1>

Although in the above-mentioned embodiment, a determination of inappropriateness is made immediately at Step S14 if the characters (character strings) and graphics (combinations of graphics) extracted at Step S12 match the characters (character strings) and graphics (combinations of graphics) registered in the inappropriate expression database, embodiments of the invention are not limited to this context.

For example, processing may be performed such that the NG level is increased if the extracted characters (character strings) and graphics (combinations of graphics) match the characters (character strings) and graphics (combinations of graphics) registered in the inappropriate expression database, and a determination of inappropriateness is made if an accumulated value of the NG levels exceeds a predetermined reference value.

In addition, the system may be adapted to calculate the degree of similarity between the extracted characters (character strings) and graphics (combinations of graphics) and the characters (character strings) and graphics (combinations of graphics) registered in the inappropriate expression database and make a determination of inappropriateness if the degree of similarity or the NG level, its accumulated value, exceeds a predetermined reference value.

### <Variation 2>

In the real world, combinations of a date and a place name are very likely to represent information specifying times and places to meet others, and sharing game images containing such information is inappropriate.

Accordingly, while in the above-mentioned embodiment a determination of inappropriateness was made if the extracted characters (character strings) and graphics (combinations of graphics) matched the characters (character strings) and graphics (combinations of graphics) registered in the inappropriate expression database, a determination of inappropriateness may be made if the extracted characters (character springs) and graphics (combinations of graphics) are a combination of a date and a place name.

### <Variation 3>

Although the above-mentioned embodiment involved a determination by the server 102 as to whether or not the game image was appropriate, the embodiments are not limited to this context.

For example, the system may be adapted such that a determination is made, on an information terminal 100, as to whether or not a game image is appropriate at the time when a user generates or edits the game image, and restrictions are imposed on the sharing of the game image.

In addition, the system may be adapted such that a determination is made on an information terminal 100 as to whether or not a game image is appropriate when a user is about to share a game image, and restrictions are imposed on the sharing of the game image.

### <Variation 4>

While the above-mentioned embodiment discussed a situation in which the game space was two-dimensional, the present invention is applicable to situations in which the game space is three-dimensional. In such a case, graphic recognition of game images may be performed based on 2D images seen from a camera viewpoint used in the editing of the game images. Alternatively, it can be performed based on 2D images seen from a camera viewpoint used when another user views the game images. Furthermore, it is possible to use information describing a 2D rearrangement of the object arrangement based on said camera viewpoint.

It should be noted that the embodiments and variations above may be implemented in combination, as need may be.

### DESCRIPTION OF THE REFERENCE NUMERALS

10 Processing unit
12 Storage unit
14 Input unit
16 Output unit
18 Communication unit
20 Processing unit
22 Storage unit
24 Input unit
26 Output unit
28 Communication unit
100 (100a, 100b) Information terminals
102 Server
104 Information communication network

1. An in-game graphic recognition system, comprising:
a graphic recognition means for analyzing and graphically recognizing game images displayed in an electronic game;
a determination means for determining whether graphics recognized by the graphic recognition means are appropriate or inappropriate by checking against an inappropriate expression database where inappropriate expressions are registered; and
an access control means for controlling access to the game images in accordance with the determination result of the determination means,
and in which the graphic recognition means extracts segments that constitute graphics from information on the arrangement of the objects forming part of the game images.

2. The in-game graphic recognition system according to claim 1, wherein the determination means calculates an accumulated value produced by accumulating the number of times a determination of inappropriateness has been made and disallows the sharing of the game images when the accumulated value exceeds a reference value.

3. The in-game graphic recognition system according to claim 1, wherein the determination means determines that a graphic recognized by the graphic recognition means is inappropriate when said graphic represents a combination of a date and a place name.

4. A non-transitory computer readable medium having machine-executable instructions for in-game graphic recognition, the machine-executable instructions directing a computer to perform:
analyzing and graphically recognizing game images displayed in an electronic game;
determining whether graphics recognized by the analyzing and graphically recognizing are appropriate or inappropriate by checking against an inappropriate expression database where inappropriate expressions are registered; and
controlling access to the game images in accordance with the determination result of the determining,
and in which the analyzing and graphically recognizing comprises extracting segments that constitute graphics from information on the arrangement of the objects forming part of the game images.
